(19) United States
(12) Patent Application Publication
(10) Pub. No.: US 2009/0136216 A1
(43) Pub. Date: May 28, 2009

(54) System and Method for Playback of Partially Available Multimedia Content

(76) Inventors: Kourosh Soroushian, San Diego, CA (US); Shaiwal Priyadarshi, San Diego, CA (US); Jason Braness, San Diego, CA (US); Roland Osborne, San Diego, CA (US); Dan Salmonsen, San Diego, CA (US); John Kelley, San Jose, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/324,779

(22) Filed: Nov. 26, 2008

Related U.S. Application Data
(60) Provisional application No. 60/990,663, filed on Nov. 28, 2007.

(51) Int. Cl. H04N 7/26

(52) U.S. Cl. 386/124; 386/E05.001

(57) ABSTRACT

Critical information or playback data is included in a media file thereby enabling multimedia content to be decoded and presented even when only some of the multimedia content is partially available.

### CROSS-REFERENCE TO RELATED APPLICATIONS

This application claims priority to U.S. Provisional Application No. 60/990,663, filed Nov. 28, 2007, the disclosure of which is incorporated herein by reference.

### BACKGROUND

The present invention relates generally to multimedia files and more specifically to multimedia files that can be played when only portions of the multimedia file are available.

The Internet revolution has brought about a fundamental change in the distribution of information in the world. The collection and distribution of knowledge amongst users has undergone a fundamental paradigm shift, where collectively created encyclopedias are as commonly used as video-sharing and downloading services. The ability to readily exchange information has also cleared the path for the distribution of multimedia content on the internet. This distribution may occur via any number of methods, including but not limited to direct-download from a server, server-managed content distribution, or through peer-to-peer torrent networks.

In recent years, certain advancements in the downloading strategies for content distribution have lead to systems that enable the piecewise downloading of a multimedia file, which can later be reassembled to provide the complete file in the correct order of bytes. Piecewise downloading may enable receiving data from multiple simultaneous sources, possibly aiding in the speed-up of the downloading of the overall file. With piecewise downloading, there is generally no predictable pattern for transmitting the different file segments, and the size of the downloaded pieces may also be indeterminable.

Typically, multimedia files are made up of specific sections such as a header, media data or payload, and an indexing section which may be optional. Typically, the header section contains technical descriptions of the media data, and without the header section the media data cannot be decoded and played back. Typically, the indexing section contains information that describes the position of media data chunks within the file, allowing for random seeking during playback. Furthermore, if the media data section contains any errors, then the data in the indexing section provides a manner by which the next error-free media data chunk can be located; therefore, the indexing section can also offer some degree of error tolerance.

While some files may employ distributed means of encapsulating the information contained in each one of these sections, it is by far more likely that certain information related to decoding is collected in one particular segment of the file. For example, in many different container formats header sections are placed as single, contiguous blocks of data at the front-end of files. Hence, the specific segmentation of critical information required for decoding a multimedia presentation may mean that until a file has been reconstructed in its entirety, it cannot be successfully decoded.

### SUMMARY

Systems and methods are described that enable multimedia content to be decoded and presented with only partially-available multimedia content including critical information or playback data.

In one embodiment, a method of playing a partially provided multimedia file comprises reading a portion of a partially provided multimedia file including content data having a plurality of media frames; identifying a critical information chunk within the plurality of chunks in the media data section, the critical information chunk including information for decoding the content data without receiving further portions of the partially provided multimedia file; decoding the content data based only on the identified critical information chunk; and presenting the decoded content data.

In another embodiment, a method of encoding a partially provided multimedia file comprises supplying content data from one or more sources; incorporating critical information prior to a key frame in the supplied content data; repeating the incorporation for one or more key frames in the supplied content data, the critical information including information for decoding the supplied content independently of other key frames or other portions of the supplied content; and generating a multimedia file from the supplied content and the incorporated critical information.

In yet another embodiment, a system for playback of a partially provided media file comprises a media server and a client processor. The media server is configured to transmit a partially provided media file having critical information proximate one or more key-frames of media content within the partially provided media file. The client processor in network communication with the media server is configured to send requests for the partially provided media file to the media server and the media server is configured to transmit the partially provided media file requested. The client processor comprises a playback engine configured to locate the critical information to independently decode the partially provided media file based on the located critical information.

The above-mentioned and other features of this invention and the manner of obtaining and using them will become more apparent, and will be best understood, by reference to the following description, taken in conjunction with the accompanying drawings. The drawings depict only typical embodiments of the invention and do not therefore limit its scope.

### BRIEF DESCRIPTION OF THE DRAWINGS

FIG. 1 is a semi-schematic illustration of a network for downloading multimedia files in accordance with an embodiment of the invention.

FIG. 2 is a conceptual illustration of a partially downloaded multimedia file.

FIG. 3 is a conceptual illustration of an information track interleaved with multimedia information within a multimedia file in accordance with an embodiment of the invention.

FIG. 4 is a conceptual illustration of a multimedia file having a critical information chunk in accordance with an embodiment of the invention.

### DETAILED DESCRIPTION

Turning now to the drawings, multimedia files and systems for progressively assembling and playing remotely stored multimedia files are described. The multimedia file can be progressively assembled from one or many sources, with different pieces used to build the entire file over time. In many embodiments of the invention, critical information or playback data required by a player to commence playing content within the multimedia file is repeated in various locations throughout the file. This critical information is information used by a player for decoding the video, audio, and other stream types in the file. For example, the critical information can include, but is not limited to, information indicative of a video codec standard, information indicative of an audio codec standard, video resolution, audio sampling rate and/or total channels. In many embodiments, the critical information is repeated within the media data section of the file, proximate access frames. In several embodiments, the critical information is included in the media data chunk of one or more or every access frame. In a number of embodiments, the critical information is included in an information chunk that is interleaved into the media data section within the file in such a way that each instance of the critical information is located proximate to one or more or every access frame. In several embodiments, the critical information provided within the multimedia file is different for two or more of the access frames and/or is not repeated with respect to each access frame in the multimedia file. In many instances, the critical information is expressed at least partially with respect to a set of pre-determined profiles. In a number of embodiments, the critical information for a conventional multimedia file is provided in a separate secondary file to facilitate playing the multimedia file during progressive download. In further embodiments, the progressive download process involves use of boundaries that are aligned with the access frames within a multimedia file.

### Architecture for Progressive Downloading of Multimedia Files

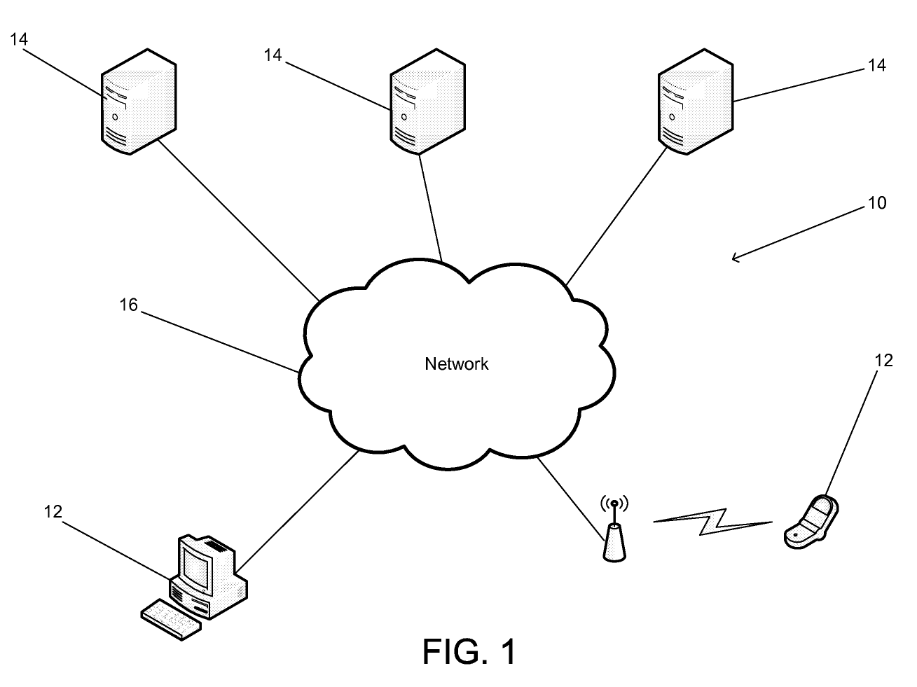

A multimedia distribution network in accordance with an embodiment of the invention is shown in FIG. 1. The distribution network 10 includes a number of devices configured as players 12. In the illustrated embodiment, the players are a personal computer and a mobile phone handset. In other embodiments, a player can be any device that can receive multimedia information via a network connection and that can play the multimedia information. The players 12 are connected to servers 14 via a network 16 and can progressively download multimedia files stored on the servers. In a number of embodiments, a player is configured to download a multimedia file from a single server. In many embodiments, a player is configured to simultaneously download a multimedia file from multiple servers. In several embodiments, the players progressively assemble multimedia files using peer-to-peer file sharing applications such as the BitTorrent application distributed by BitTorrent, Inc. of San Francisco, Calif. In other embodiments, the players can use other applications to progressively download multimedia files from one or more servers.

Repetition of Critical Information or Playback Data within a Multimedia File

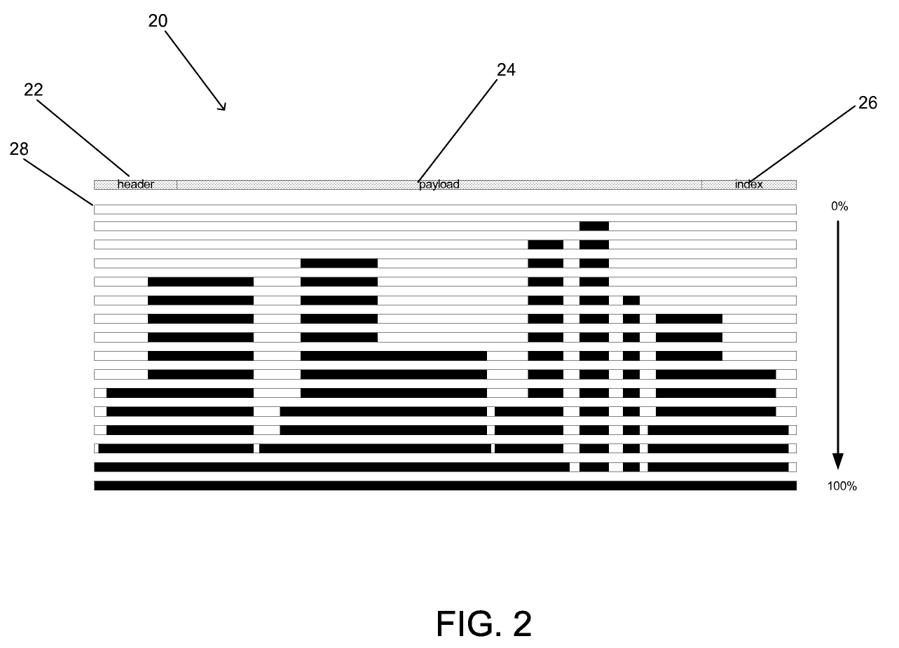

A hypothetical build-up of a multimedia file as it is progressively downloaded is illustrated in FIG. 2. The different sections of the multimedia file 20 are separately illustrated. The multimedia file includes a header 22, payload 24, and index 26. Several hypothetical snapshots 28 of the pieces of the file that are received by a player during the progressive download of the file over time are illustrated. The snapshots show the gradual completion of the progressive download of the multimedia file from 0% to 100%. When a multimedia file is progressively downloaded, a significant Latency can exist between the commencement of the download and the point in time at which the entire header can be reconstructed by the player. The Latency is represented in the hypothetical download by the fact that the header is not downloaded until the 14^{th} snapshot in time. Because of this download pattern, a conventional multimedia file that has had a considerable proportion of its content downloaded may not be playable if a critical section Lies in the header segment of the file. Furthermore, if the header portion were not downloaded by the receiver at all then the rest of the file may not be playable, even if all other sections of the file had been downloaded without error. It is important to highlight that in other embodiments, the header section in FIG. 2 may be replaced with any section of a multimedia file that contains the required description for commencing playback of the audio and video streams.

Multimedia files in accordance with embodiments of the invention include critical information in multiple Locations throughout the file. As soon as a player receives the critical information, the player has the capability of playing content within the multimedia file that has already been downloaded. In several embodiments, the critical information is paired with the multimedia information to which it relates. Therefore, the critical information is downloaded as the multimedia information is downloaded. The manner in which the information is encoded and the frequency with which the critical information is repeated throughout the multimedia file can be determined by the total amount of information necessary to successfully decode the presentation and/or the requirements of a particular application.

Pairing Critical Information with Access Frames

Generally, multimedia files have access frames which can be decoded and presented independently, without the need for any prior or future information in the payload section. When a user instructs a player to play from a particular access frame, the player can play the content once it has been downloaded provided the critical information necessary for successfully decoding and presenting the multimedia data is available to the player. In many embodiments, the critical information is provided in conjunction with the access frames. In a number of embodiments, the access frames are included within containers in the multimedia file and the critical information is expressed in the header of the container. In other embodiments, the critical information can be expressed in other locations within the multimedia file.

### Separate Information Tracks

Multimedia files in accordance with several embodiments of the invention can include separate information tracks that are interleaved with the multimedia content within the file so that the critical information appears immediately before one or more or each access frame or proximate an access frame. In many embodiments, the information track contains a unique marker, which can be any number of bits but is typically 4 to 16 bytes or longer, that can be uniquely identified with a reasonably low probability of unintentional emulation in the payload data. The information track can express the critical information in any manner including those outlined above involving references to pre-determined profiles and/or the direct specification of parameters for the audio, video, subtitle and/or other streams that follow the portion of the information track containing the critical information.

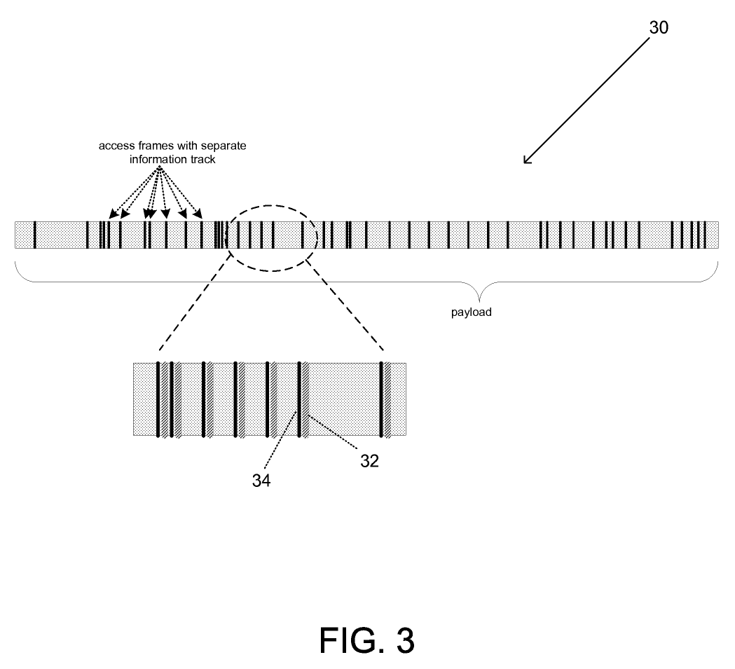

A multimedia file including an information track in accordance with an embodiment of the invention is illustrated in FIG. 3. The multimedia file 30 includes interleaved multimedia information. The multimedia information can include, but is not limited to, video, audio, subtitle and/or information tracks. The multimedia information includes a number of access frames 32. Information 34 from the information track is interleaved immediately prior to the access frames. In other embodiments, the information can follow the access frames. The information 34 includes critical information used by a player to decode the access frame 32. In many embodiments, the information 34 also includes other information concerning the decoding of the overall multimedia file.

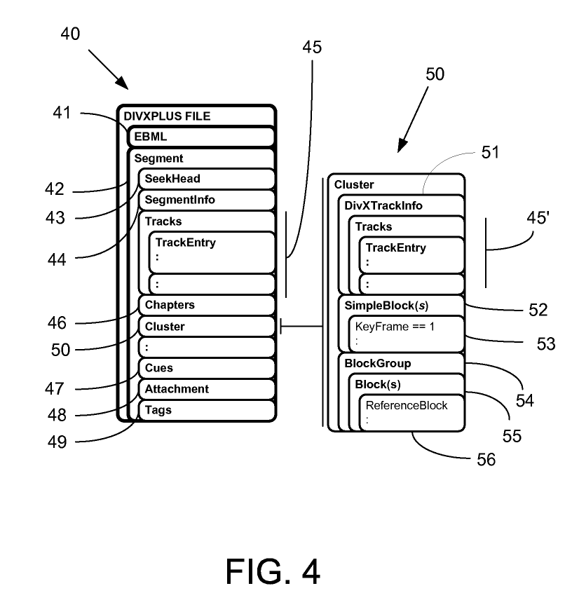

In FIG. 4, a multimedia file in accordance with an embodiment of the invention further illustrates the critical information relative the file. The multimedia file 40 includes an EBML (Extensible Binary Meta Language) element 41 and a Segment element 42. The segment element includes seek head 43, segment information 44, Tracks 45, Chapters 46, one or more Clusters 50, Cues 47, Attachments 48 and Tags 49. The Tracks 45 with one or more track entries includes information, i.e., playback data, about each of the audio, video, subtitle and/or other media tracks (for example, metadata). Within the clusters 50, track information 51 may be co-located with one or more simple blocks 52 and/or one or more block groups 54. The blocks or block groups contain audio, video, subtitle and/or other media frames. The simple blocks in one embodiment include a key or access frame identifier 53 which for example is set to identify a block having a key frame. The block groups include blocks 55, similar to a simple block 52 but utilize the lack of a reference block value as the method of indicating that the contained frame is a key-frame (i.e. it does not have any reference frames). The block or blocks 55 in the illustrated case also includes a reference block 56, i.e., time code of another frame. As illustrated, the track information 51 includes duplicated track information, track 45′, which corresponds to the track information 45 in the segment element 42. The track information provides all the necessary information, e.g., audio/video codec information, to playback the content or frames in the associated cluster. As such, each cluster that contains a key-frame optionally may also have the playback data or critical information in the form of the track information 51 to present the video, audio subtitle and/or other tracks associated with the given cluster. The track information 51 may be present in each cluster that contains a key-frame, or may optionally appear at a lower frequency such as 10 or 20 occurrences per file. A lower frequency may increase seek time to find the critical information but it will also reduce the file size of the multimedia file. Thus, the critical information may be proximate one or more or every key-frame, the frequency of which can affect the seek time and the multimedia file size.

### Expressing Critical Information

Repetition of critical information throughout a multimedia file increases the file's overhead. In order to reduce the number of bits required to express the critical information, a series of encoding profiles can be established for multimedia content and references to profiles can be used within a multimedia file as opposed to specifying critical information in its entirety multiple times throughout the file. In many embodiments, profiles including sets of predetermined parameters for audio, video, subtitle, and other pertinent data are pre-defined. As discussed above, multimedia files in accordance with many embodiments of the invention include a profile reference in the containers containing access frames and/or as data within a separate information track. The pre-determined parameters specified in a profile can include, but are not limited to, video horizontal and vertical resolution, video frame-rate, audio sampling rate, audio channel number, subtitle format, video and audio codec type, and/or subtitle resolution. The selection for the particular profile may be done via an indicator in the container which encapsulates the access frames.

In a number of embodiments, the multimedia file can directly specify certain aspects of the critical information and provide references to pre-determined profiles for other aspects of the critical information. For example, the horizontal and vertical resolutions for the video portion could be specified independently, while all other parameters are selected from the pre-determined profiles. In several embodiments, restrictions are imposed on the independently-specified parameters. For example, horizontal and vertical resolutions can be limited to units of 4, 8, 16 or larger pixels. The manner in which references to pre-determined profiles and/or directly specified parameters are encoded within a multimedia file in accordance with an embodiment of the invention typically depends upon the requirements of a particular application. Any of a variety of formats can be specified. The encoding typically involves balancing ease of decoding with limiting the amount of overhead within the multimedia file.

### Identifying Access Frames or Critical Information During Progressive Download

In order to easily identify access frames, these frames can have a stream identifier that is different from the stream identifier used to indicate non-access frames. This stream identifier may be 4 bytes, or more, and a requirement may be placed on all individual frames in the payload section such that they start on a four-byte aligned boundary. This may facilitate the search for access frames and reduce the probability that the stream marker is emulated by the payload data.

Applications that are used to progressively download multimedia files in accordance with embodiments of the invention can require that utilities which may be used to distribute the file via a network perform any data partitioning on a boundary that is aligned with the start of one or more or each access frame, or one or more or each critical information chunk. In this way, each segment starts with an access frame or critical information chunk and a separate marker as well as a seek operation in the decoder can be omitted.

### Providing Critical Information in a Secondary File

In a number of embodiments, a player progressively downloading a multimedia file also obtains a secondary file that specifies the location of one or more or every access frame, or critical information chunk in the multimedia file, along with the appropriate header and index information for the multimedia file. In this way, the secondary file can be obtained in its entirety and used as a guide in playing back partial sections of the multimedia file. In several embodiments, the secondary file is expected to be much smaller than the multimedia file, and as a result can be more rapidly obtained via a network-based distribution method. A secondary file can be particularly useful in applications where a significant number of conventional multimedia files exist. Use of secondary files can be more desirable than re-encoding each of the existing multimedia files.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method of playing a partially provided multimedia file, the method comprising:
reading a portion of a partially provided multimedia file including content data having a plurality of media frames;
identifying a critical information chunk within the plurality of chunks in the media data section, the critical information chunk including information for decoding the content data without receiving further portions of the partially provided multimedia file;
decoding the content data based only on the identified critical information chunk; and
presenting the decoded content data.

2. The method of claim 1 wherein the critical information chunk is a repetition of one or more or all media data track headers.

3. The method of claim 1 wherein the critical information chunk includes a video codec identifier.

4. The method of claim 1 further comprising receiving the critical information chunk as a separate file different from the partially provided multimedia file.

5. The method of claim 1 further comprising locating a pointer to the critical information chunk.

6. The method of claim 1 further comprising storing the identified critical information chunk.

7. The method of claim 6 further comprising retrieving the stored critical information chunk for one or more key frames.

8. The method of claim 1 wherein the critical information chunk is located proximate to one or more key-frames throughout the partially provided multimedia file.

9. The method of claim 1 wherein the critical information chunk differs between one or more key-frames.

10. The method of claim 1 wherein the information of the critical information chunk is based on a profile specifying at least one of video resolution, video frame-rate, audio sampling rate, audio channel number, subtitle form, video codec type, audio codec type and subtitle resolution.

11. A method of encoding a partially provided multimedia file, the method comprising:
supplying content data from one or more sources;
incorporating critical information prior to a key frame in the supplied content data;
repeating the incorporation for one or more key frames in the supplied content data, the critical information including information for decoding the supplied content independently of other key frames or other portions of the supplied content; and
generating a multimedia file from the supplied content and the incorporated critical information.

12. The method of claim 11 wherein the critical information includes at least one of a video codec identifier, an audio codec identifier, video resolution, audio sampling rate and audio total channels.

13. The method of claim 11 wherein the incorporation of critical information is for every key frame.

14. The method of claim 11 further comprising generating a critical information file being different from the multimedia file and including the information for decoding the supplied content independently of other key frames or other portions of the supplied content and the incorporated critical information referencing the critical information file.

15. The method of claim 11 wherein the critical information comprises track headers of the supplied content.

16. The method of claim 11 wherein the critical information differs between one or more key-frames.

17. The method of claim 11 further comprising incorporating references to a profile providing playback information differing from the incorporated critical information.

18. The method of claim 11 wherein incorporating the critical information further comprises incorporating the critical information in a container header of one or more key-frame.

19. The method of claim 11 wherein a plurality of key frames within the supplied content data within a payload starts on a four-byte aligned boundary.

20. The method of claim 11 wherein incorporating the critical information further comprises encoding an information track having the critical information and interleaving the information track into content data of the multimedia file.

21. A system for playback of a partially provided media file, comprising:
a media server configured to transmit a partially provided media file having critical information proximate one or more key-frames of media content within the partially provided media file; and
a client processor in network communication with the media server and configured to send requests for the partially provided media file to the media server, the media server configured to transmit the partially provided media file requested, the client processor comprises a playback engine configured to locate the critical information to independently decode the partially provided media file based on the located critical information.

22. The system of claim 21 wherein the critical information includes at least one of a video codec identifier, an audio codec identifier, video resolution, audio sampling rate and audio total channels.

23. The system of claim 21 wherein the critical information comprises track headers of the media content.

24. The system of claim 21 further comprising locating a stream identifier indicating a key-frame.

25. The system of claim 21 wherein the media server transmits the partially provided media file in data partitions, each partition aligned with a start of one or more key-frames or critical information chunks.
